(19) United States
(12) Patent Application Publication
(10) Pub. No.: US 2013/0284367 A1
(43) Pub. Date: Oct. 31, 2013

(54) SUBSTRATE PROCESSING APPARATUS AND METHOD OF SUPPLYING PROCESSING SOLUTION

(71) Applicant: SEMES CO., LTD., Chungcheongnam-do (KR)

(72) Inventors: Byung Chul Kang, Chungcheongnam-do (KR); Bong Joo Kim, Chungcheongnam-do (KR); Byung Man Kang, Chungcheongnam-do (KR); Young Ho Choo, Chungcheongnam-do (KR)

(21) Appl. No.: 13/873,304

(22) Filed: Apr. 30, 2013

(30) Foreign Application Priority Data
Apr. 30, 2012 (KR) 10-2012-0045738
Oct. 22, 2012 (KR) 10-2012-0117204

(51) Int. Cl. B05C 11/10; B05D 1/00

(52) U.S. Cl. CPC B05C 11/1042; B05D 1/00
USPC 156/345.18; 137/3

(57) ABSTRACT

Provided is a substrate processing apparatus. The apparatus includes a processing chamber containing a substrate and processing the substrate by using a processing solution and a supplying unit supplying the processing solution to the processing chamber. The supplying unit includes a supply line through which the processing solution is supplied, a preliminary heater installed on the supply line and preliminary heating the processing solution, a main heater installed on the supply line at a lower stream of the preliminary heater and secondarily heating the processing solution, a first detour line connected to the supply line to detour to the preliminary heater and comprising a first valve, a second detour line connected to the supply line to detour the preliminary heater and the main heater or the main heater and comprising a second valve, and a controller controlling the first valve and the second valve.

### CROSS-REFERENCE TO RELATED APPLICATIONS

This U.S. non-provisional patent application claims priority under 35 U.S.C. §119 of Korean Patent Application Nos. 10-2012-0045738, filed on Apr. 30, 2012, and 10-2012-0117204, filed on Oct. 22, 2012, the entire contents of which are hereby incorporated by reference.

### BACKGROUND OF THE INVENTION

The present invention relates to a substrate processing apparatus, and more particularly, to a substrate processing apparatus capable of mixing a plurality of chemicals and controlling a temperature of a solution obtained by mixing the chemicals to be used for processing a substrate and a method of supplying the solution.

Generally, processes of manufacturing semiconductor devices, flat panel display devices, or solar cells are performed through thin film vapor depositing processes, etching processes, and cleaning processes. Among these manufacturing processes, in etching processes and cleaning processes, various kinds of chemicals are used. For example, various kinds of processing solutions may be etching solutions, developing solutions, and cleaning solutions.

For etching processes or cleaning processes, processing solutions obtained by mixing a plurality of kinds of chemicals at a certain ratio are used. Processing solutions are supplied to chambers or processing rooms by chemical supplying apparatuses. Chemical supplying apparatuses control concentrations and temperatures of processing solutions and chemicals in two vessels corresponding to conditions of corresponding processes and supply the same.

Since general chemical supplying apparatuses previously prepare concentrations and temperatures of processing solution to be used in two vessels and supply the same to chambers, preparing times are needed. Also, to change temperatures of processing solutions while the temperatures are determined once and prepared, preparing times are needed. To change concentrations of processing solutions while ratios are determined once and prepared, preparing times are needed.

As described above, since processing solutions previously prepared by chemical supplying apparatuses are supplied to all chambers as the same conditions, it is impossible to change conditions of processing solutions for respective chambers. Also, according to levels of use, there are limitations in lifetimes.

### SUMMARY OF THE INVENTION

The present invention provides a substrate processing apparatus capable of obtaining a processing solution by mixing chemicals at a desired ratio in real time and then increasing a temperature of chemicals at a room temperature to be supplied and a method of supplying the processing solution.

The present invention also provides a substrate processing apparatus capable of supplying processing solutions having different conditions to respective chambers and a method of supplying the processing solutions.

The present invention also provides a substrate processing apparatus capable of changing a temperature and a flow of a processing solution in real time and a method of supplying the processing solution.

The present invention also provides a substrate processing apparatus capable of preventing temperature hunting that instantly occurs and a method of supplying a processing solution in the apparatus.

The present invention also provides a substrate processing apparatus capable of maintaining a temperature at a nozzle part to be uniform although a processing solution is not ejected and a method of supplying the processing solution.

The aspect of the present invention is not limited thereto and other aspects not mentioned above will be definitely understood by a person skilled in the art from the following description.

Embodiments of the present invention provide substrate processing apparatuses including a processing chamber containing a substrate and processing the substrate by using a processing solution and a supplying unit supplying the processing solution to the processing chamber. The supplying unit includes a supply line through which the processing solution is supplied, a preliminary heater installed on the supply line and preliminary heating the processing solution, a main heater installed on the supply line at a lower stream of the preliminary heater and secondarily heating the processing solution, a first detour line connected to the supply line to detour to the preliminary heater and comprising a first valve, and a controller controlling the first valve.

In some embodiments, the apparatus may further include a second detour line connected to the supply line to detour to the preliminary heater and the main heater or the main heater and comprising a second valve controlled by the controller.

In other embodiments, the apparatus may further include a return line connected to the supply line to allow the processing solution to return from a lower stream of the main heater to an upper stream of the preliminary heater.

In still other embodiments, the main heater may be a water bath heater to precisely control a temperature of the processing solution.

In even other embodiments, the apparatus may further include a rate controller installed on the supply line, receiving one or more chemicals from one or more chemical suppliers and supplying a mixed processing solution to the preliminary heater.

In yet other embodiments, a flow controller controlling a flow of the chemicals may be installed on a line connecting the rate controller and the chemical suppliers.

In other embodiments of the present invention, methods of supplying a processing solution includes receiving and mixing chemicals from one or more chemical suppliers, preliminary increasing a temperature of a mixed processing solution to a determined degree of temperature while the mixed processing solution passes through a preliminary heater, and secondarily increasing the temperature of the processing solution to the determined degree of temperature by a main heater. When over shooting occurs in the preliminary heater, a part of the processing solution at a room temperature flowing through a first detour line detouring to the preliminary heater may be mixed with the processing solution whose temperature is preliminary increased.

In some embodiments, when to decrease a temperature of the processing solution in real time, whose temperature is increased to the determined degree at the secondarily increasing the temperature, a part of the processing solution at the room temperature flowing through a second detour line detouring to the preliminary heater and the main heater may be mixed with the processing solution whose temperature is secondarily increased.

In other embodiments, a water bath heater may be used at the secondarily increasing the temperature in order to precisely increase the temperature of the processing solution.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a top view schematically illustrating a substrate processing system;

FIG. 2 is a cross-sectional view illustrating a substrate processing apparatus;

FIG. 3 is a configuration view illustrating processing solution supplying units provided for the respective substrate processing apparatuses; and

FIG. 4 is a configuration view illustrating the processing solution supplying unit.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

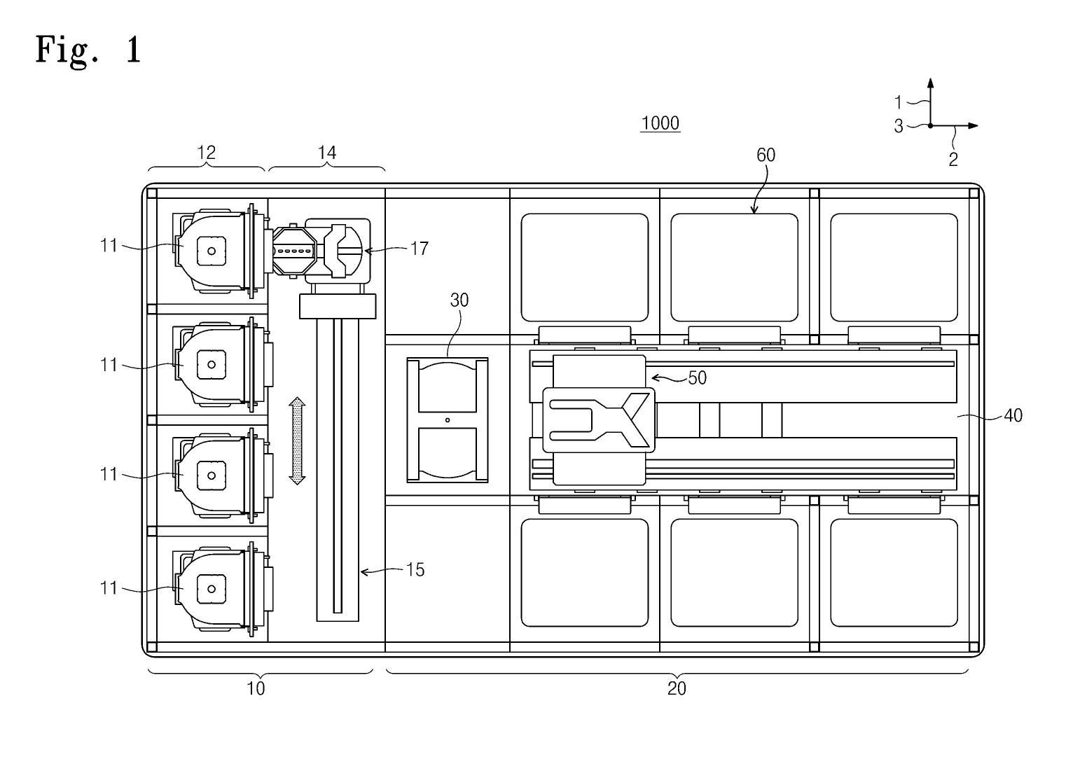

FIG. 1 is a top view schematically illustrating a substrate processing system 1000.

Referring to FIG. 1, the substrate processing system 1000 may include an index part 10 and a processing part 20. The index part 10 and the processing part 20 are arranged in a row. Hereinafter, a direction in which the index part 10 and the processing part 20 are arranged is designated as a first direction 1, a direction vertical to the first direction 1 in a top view is designated as a second direction 2, and a direction vertical to a plane including the first direction 1 and the second direction 2 is designated as a third direction 3.

The index part 10 is arranged in a front of the substrate processing system 1000 in the first direction 1. The index part 10 includes a load port 12 and a transfer frame 14.

A carrier 11 containing a substrate W is seated on the load port 12. The load port 12 is provided in a plurality thereof and arranged in a row along the second direction 2. The number of the load ports 12 may increase or decrease according to processing efficiency and a footprint condition of the substrate processing apparatus 1000. As the carrier 11, a front opening unified pod (FOUP) may be used. A plurality of slots for containing substrates to be level to the ground surface is formed on the carrier 11.

The transfer frame 14 is arranged in the first direction adjacent to the load port 12. The transfer frame 14 is arranged between the load port 12 and a buffer unit 30 of the processing part 20. The transfer frame 14 includes an index rail 15 and an index robot 17. The index robot 17 is seated on the index rail 15. The index robot 17 transfers the substrate W between the buffer unit 30 and the carrier 11. The index robot 17 moves straightly along the index rail 15 in the second direction 2 or rotates around the third direction 3.

The processing part 20 is arranged in a rear of the substrate processing system 1000 in the first direction 1, adjacent to the index part 10. The processing part 20 includes the buffer unit 30, a transfer path 40, a main transfer robot 50, and a substrate processing apparatus 60.

The buffer unit 30 is arranged in a front of the processing part in the first direction 1. The buffer unit 30 is a place where the substrate W is temporarily stored and on standby before being transferred between the substrate processing apparatus 60 and the carrier 11. The buffer 30 is provided with slots (not shown) on which the substrate W is disposed, therein, and the slots are provided in a plurality thereof and separated from one another in the third direction 3.

The transfer path 40 is arranged corresponding to the buffer unit 30. The transfer path 40 is arranged to allow a longitudinal direction thereof to be parallel to the first direction 1. The transfer path 40 provides a path via which the main transfer robot 50 moves. On both sides of the transfer path 40, the substrate processing apparatuses 60 are arranged in the first direction while facing one another. On the transfer path 40, there is installed a moving rail to allow the main transfer robot 50 to move in the first direction 1 and to ascend and descend between a top and a bottom of the substrate processing apparatus 60 and between a top and a bottom of the buffer unit 30.

The main transfer robot 50 is installed on the transfer path 40 and transfers the substrate W between the substrate processing apparatus 60 and the butter unit 30 or between the respective substrate processing apparatus 60. The main transfer robot 50 straightly moves along the transfer path 40 in the second direction 2 or rotates around the third direction 3.

The substrate processing apparatus 60 is provided in a plurality thereof and arranged on both sides of the transfer path 40 in the second direction 2. Some of the substrate processing apparatuses 60 are arranged in a longitudinal direction of the transfer path 40. Also, some of the substrate processing apparatuses 60 are arranged while being stacked on one another. That is, the substrate apparatuses 60 may be arranged in A×B on one side of the transfer path 40. In this case, A is the number of the substrate processing apparatuses 60 arranged in a row in the first direction 1 and B is the number of the substrate processing apparatuses 60 arranged in a row in the second direction 2. When 4 or 6 of the substrate processing apparatuses 60 are provided on one side of the transfer path 40, the substrate processing apparatuses 60 may be arranged as one of 2×2 or 3×2. The number of the substrate processing apparatuses 60 may increase or decrease. Different from the described above, the substrate processing apparatuses 60 may be provided on only one side of the transfer path 40. Also, differently, the substrate processing apparatuses 60 may be provided as a single layer on one side or both sides of the transfer path 40.

The substrate processing apparatus 60 may perform a process of cleaning the substrate W. The substrate processing apparatuses 60 may have different structures according to the kind of cleaning processes to be performed. Differently, the respective substrate processing apparatuses 60 may have the same structure. Optionally, the substrate processing apparatuses 60 are classified into a plurality of groups, in which the substrate processing apparatuses 60 included in the same group may have the same structure and the substrate processing apparatuses 60 included in different groups may have different structures from one another. For example, when the substrate processing apparatuses 60 are classified into two groups, the substrate processing apparatuses 60 of a first group may be provided on one side of a transfer path 40 and the substrate processing apparatuses 60 of a second group may be provided on another side of the transfer path 40. Optionally, the substrate processing apparatuses 60 of the first group may be provided at lower layers of both sides of the transfer path 40 and the substrate processing apparatuses 60 of the second group may be provided at an upper layer thereof The substrate processing apparatuses 60 of the first group and the substrate processing apparatuses 60 of the second group may be classified according to the kind of used chemicals or the kind of cleaning methods thereof Differently, the substrate processing apparatuses 60 of the first group and the substrate processing apparatuses 60 of the second group may be provided to sequentially perform processes on one substrate W.

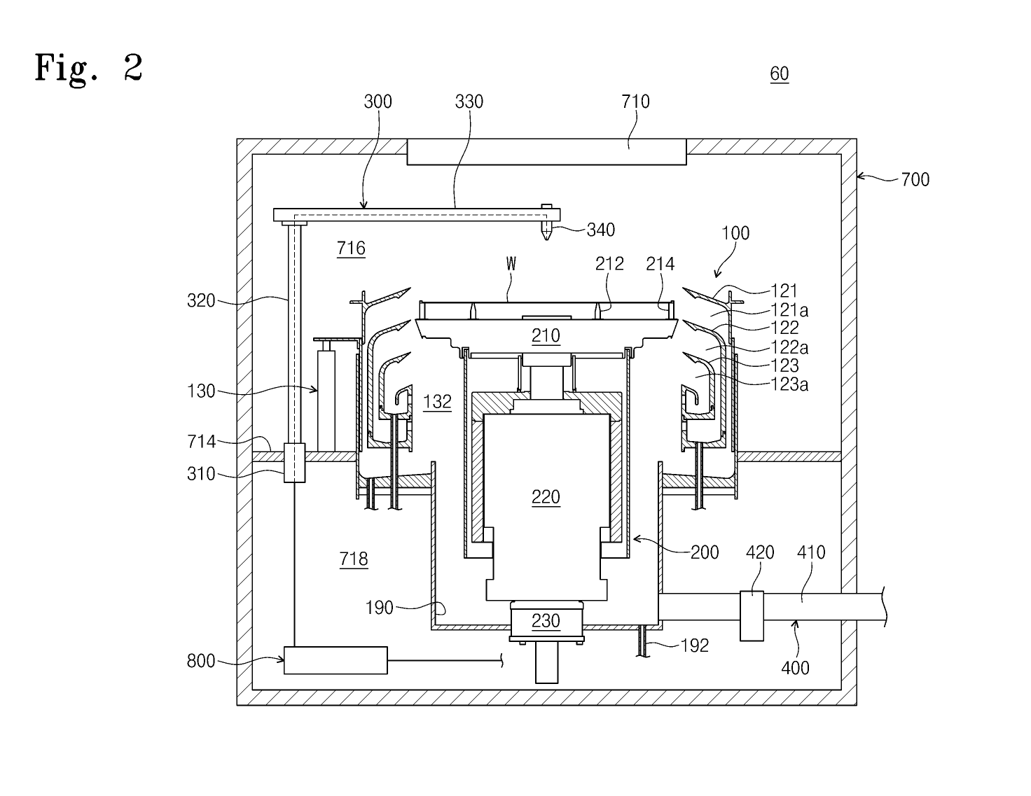

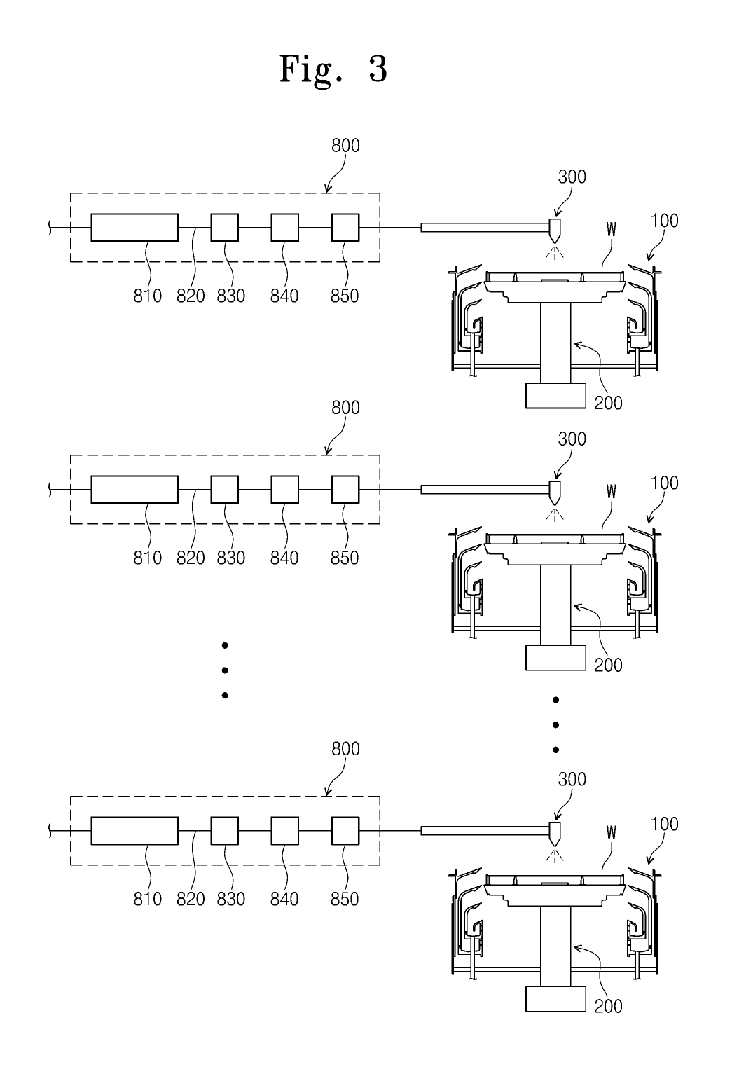

FIG. 2 is a cross-sectional view illustrating the substrate processing apparatus 60, and FIG. 3 is a configuration view illustrating processing solution supplying units 800 provided for the respective substrate processing apparatuses 60.

In the present embodiment, as an example, an apparatus of cleaning a substrate by using a processing solution will be described. However, the technical scope of the present invention is not limited thereto and may be applied to various kinds of apparatuses performing processes such as etching processes while providing process solutions to substrates.

Also, in the present embodiment, although a semiconductor substrate will be described as a substrate processed by the substrate processing apparatus, the present invention is not limited thereto and may be applied to various kinds of substrates such as glass substrates.

Referring to FIGS. 2 and 3, the substrate processing apparatus 60 includes a processing chamber 700, a processing container 100, a substrate supporting element 200, a spray element 300, and the processing solution supplying unit 800.

The processing chamber 700 provides an enclosed space, and a fan filter unit 710 is installed on a top thereof The fan filter unit 710 generates an air pocket inside the processing chamber 700.

The fan filter unit 710 is a module formed of a filter and an air supplying fan and is a device filtering a fresh air and supplying the same into the processing chamber 700. The fresh air passes through the fan filter unit 710 and is supplied to the processing chamber 700, thereby forming the air pocket. The air pocket provides a uniform air current above the substrate W and polluted gases such as fumes generated while processing a surface of the substrate W by a processing solution are discharged to a exhaust element 400 via colleting containers of the processing container 100 together with the air and are removed, thereby maintaining cleanliness inside the processing container 100.

The processing chamber 700 is partitioned into a processing area 716 and a maintenance area 718 by a horizontal partition. Although partially shown in the drawing, the maintenance area 718 is a space in which the processing solution supplying unit 800 connected to a spray nozzle 340 of the spray element 300 is located in addition to collecting lines 141 and 145 and a sub exhaust line 410 connected to the processing container 100, which may be separated from the processing area 716 for processing the substrate W.

The processing container 100 has the shape of a cylinder having an open top and provides a processing space for processing the substrate W. The open top of the processing container 100 is provided as a path for carrying the substrate W. In the processing space, the substrate supporting element 200 is located. The processing container 100 is provided with a exhaust duct 190 connected to the exhaust element 400 below the processing space. The exhaust duct 190 is provided with a drain line 192 on a bottom surface.

The processing container 100 includes collecting vessels 121, 122, and 123 and a first ascending element 130.

The collecting vessels 121, 122, and 123 are arranges as multiple stages to suck in chemicals scattered onto the rotating substrate W and gases. The respective collecting vessels 121, 122, and 123 may collect different processing solutions used for processing.

The third collecting vessel 123 is formed in the shape of a ring surrounding the substrate supporting element 200, the second collecting vessel 122 is formed in the shape of a ring surrounding the third collecting vessel 123, and the first collecting vessel 121 is formed in the shape of a ring surrounding the second collecting vessel 122. An inner space 123a of the third collecting vessel 123 is provided as an inlet via which the chemicals and gases are sucked into the third collecting vessel 123. A space between the third collecting vessel 123 and the second collecting vessel 122 is provided as an inlet via which the chemicals and gases are sucked into the second collecting vessel 122. Also, a space between the second collecting vessel 122 and the first collecting vessel 121 is provided as an inlet via which the chemicals and gases are sucked into the first collecting vessel 121.

In the present embodiment, the processing container 100 is shown as to have three collecting vessels but not limited thereto and may include two collecting vessels or three or more collecting vessels.

The exhaust element 400 is to provide exhaust pressure to the inside of the processing container 100 while processing the substrate W. The exhaust element 400 includes the sub exhaust line 410 connected to the exhaust duct 190 and a damper 420. The sub exhaust line 410 receives exhaust pressure from an exhaust pump (not shown) and is connected to a main exhaust line buried in a bottom space of the semiconductor manufacturing line.

The substrate supporting element 200 supports and rotates the substrate W while performing the process. The substrate supporting element 200 includes a spin head 210, a supporting axis 220, and a rotation-driver 230. The spin head includes supporting pins 212 and chuck pins 214. The spin head 210 has a top surface formed in an approximately circular shape from a top view. The supporting axis 220 that is rotatable is fixed to and coupled with a bottom surface of the spin head 210 by the rotation-driver 230.

The spray element 300 receives a processing solution from the processing solution supplying unit 800 and sprays the processing solution to a processed surface of the substrate W put on the spin head 210 of the substrate supporting element 200. The spray element 300 includes a supporting axis 320, a driver 310, a nozzle supporting bar 330, and the spray nozzle 340. In the case of the supporting axis 320, a longitudinal direction thereof is provided as the third direction 3 and a bottom end there is coupled with the driver 310. The driver 310 allows the supporting axis 320 to rotate and to straightly move. The nozzle supporting bar 330 is coupled with the supporting axis 320 and transfers the spray nozzle 340 toward the top of the substrate W or allows the spray nozzle 340 to move above the substrate W while spraying the processing solution.

The spray nozzle 340 is installed on a bottom surface of an end of the nozzle supporting bar 330. The spray nozzle 340 is transferred to a processing position and a standby position by the driver 310. The processing position indicates a position of the spray nozzle 340 disposed vertically to the top of the processing container 100, and the standby position is a position of the spray nozzle 340 out of being vertical to the top of the processing container 100. The spray nozzle 340 sprays the processing solution supplied from the processing solution supplying unit 800. Also, the spray nozzle 340 may directly receive and spray another processing solution in addition to the processing solution supplied from the processing solution supplying unit 800.

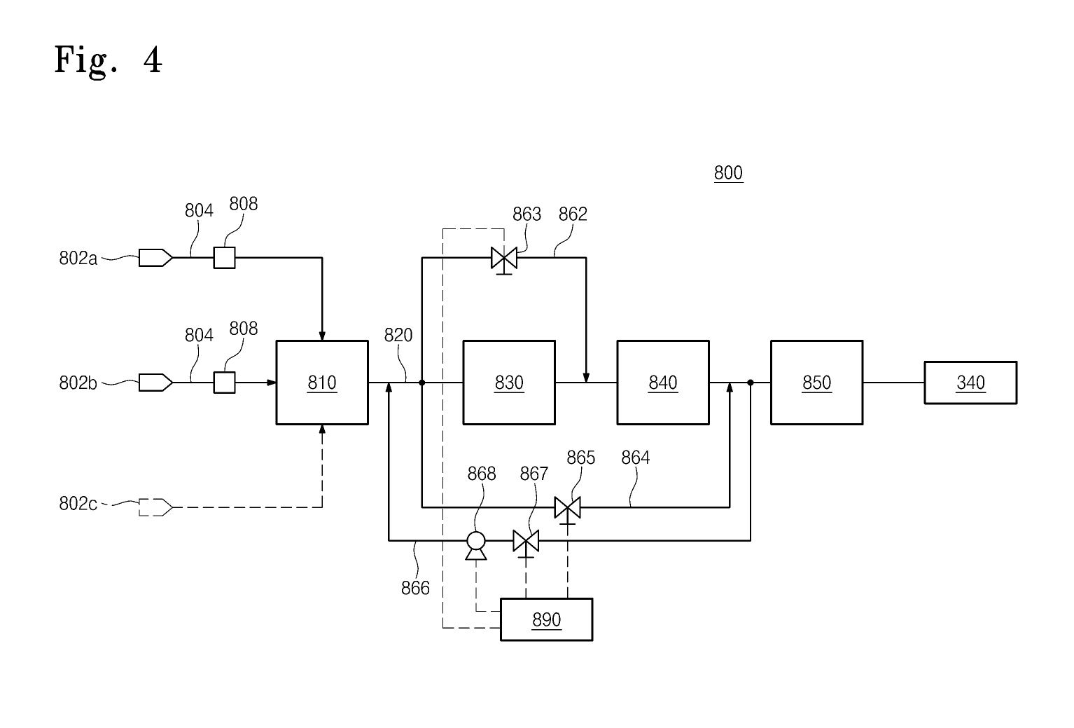

FIG. 4 is a configuration view illustrating the processing solution supplying unit 800.

Referring to FIG. 4, the processing solution supplying unit 800 includes a rate controller 810, a supply line 820, a preliminary heater 830, a main heater 840, a flow controller 850, a first detour line 862, a second detour line 864, a return line 866, and a controller 890.

The rate controller 810 receives chemicals from one or more chemical suppliers. As an example, the rate controller 810 may receive chemicals to be mixed, from first and second chemical suppliers 802a and 802b. A flow controller 808 controlling a flow of chemicals may be installed on a line 804 connecting one of the first and second chemical suppliers 802a and 802b and the rate controller 810 to one another. The flow controller 808 may include a liquid flow controller LFC. That is, the first and second chemical suppliers 802a and 802b may supply chemicals with pressures within a predetermined range as amounts of the chemicals determined by the flow controller 808.

That is, a plurality of chemicals are controlled in amounts thereof by the flow controller 808 and mixed and then mixed once again while passing through the rate controller 810 inline. Accordingly, the processing solution supplying unit 800 does not need to include a mixing tank for mixing chemicals.

On the other hand, although there are shown only the first chemical supplier 802a and the second chemical supplier 802b in FIG. 4, chemical suppliers may be three or more and one of them may be a distilled water (DIW) supplier 802c. Controlling a temperature of chemicals using distilled water may be preliminary performed by properly mixing hot DIW and cool DIW to be at a desired temperature and secondarily performed by precisely controlling using the main heater 840.

Mixed chemicals (hereinafter, referred to as a processing solution) mixed inline by the rate controller 810 are supplied to a processing solution using unit. A mixed chemical using unit may be, for example, a processing chamber or a spray element, and the processing solution may be supplied to the substrate W via the spray nozzle 340.

On the other hand, the processing solution mixed by the rate controller 810 may be measured in concentration by a concentration meter (not shown) connected to the rate controller 810. That is, the concentration of the processing solution may be immediately measured by the concentration meter connected to the rate controller 810.

The processing solution mixed by the rate controller 810 is supplied to the spray element 340 via the supply line 820.

In the supply line 820, the preliminary heater 830, the main heater 840, and the flow controller 850 are sequentially installed.

The preliminary heater 830 is installed on the supply line 820 between the rate controller 810 and the main heater 840. The processing solution preliminary increases in a temperature to a most adjacent degree to a desired temperature that is a determined temperature while passing through the preliminary heater 830. For example, the preliminary heater 830 may be a heating lamp.

The main heater 840 is installed on the supply line 820 between the preliminary heater 830 and the flow controller 850. The processing solution precisely increases in temperature to the desired degree that is the determined degree while passing through the main heater 840. For example, the main heater 840 may be a water bath heater to precisely adjust the temperature of the processing solution. The water bath heater may include a water bath tub filled with a liquid for water bath, a heater heating water for water bath to a certain degree of temperature, and a heat exchange pipe through which the processing solution to be heated passes. The processing solution precisely increases in temperature to the determined degree while passing through the heat exchange pipe of the water bath heater. In the water bath heater, constant temperature water is used when the determined degree of temperature of the processing solution is 100 degrees or less, and silicone oil is used when the determined degree of temperature of the processing solution is 100 degrees or more.

The first detour line 862 is connected to the supply line 820 to detour to the preliminary heater 830. A first valve 863 is installed on the first detour line 862. A part of the processing solution may flow while detouring to the preliminary heater 830 via the first detour line 862. As an example, when over shooting occurs in the preliminary heater 830, to prevent this, a part of the processing solution at a room temperature is allowed to detour via the first detour line 862 to be mixed with the processing solution whose temperature is increased by the preliminary heater 830, thereby controlling the temperature of the processing solution flowing into the main heater 840.

The second detour line 864 is connected to the supply line 820 to detour to the preliminary heater 820 and the main heater 840. A second valve 865 is installed on the second detour line 864. A part of the processing solution may detour to the preliminary heater 820 and the main heater 840 via the second detour line 864 and then may join the supply line 820. As an example, when to decrease the temperature of the processing solution whose temperature is increased to the determined degree by the main heater 840 in real time, the temperature of the processing solution may be controlled in real time by mixing the processing solution at a room temperature, flowing via the second detour line 864. In the present embodiment, the second detour line 864 detours to the preliminary heater 830 and the main heater 840. However, as another example, the second detour line 864 may be connected to the supply line 820 to detour to the main heater 840.

The return line 866 is connected to the supply line 820 to allow the processing solution to return to an upstream of the preliminary heater 830 from a lower stream of the main heater 840. A third valve 867 and a circulation pump 868 may be installed on the return line 866. When supplying the processing solution stops, a temperature of chemicals inside the supply line 820 drops. To prevent this, the processing solution inside the supply line 820 is circulated via the return line 866 after the supplying the processing solution stops, thereby maintaining the temperature of the processing solution inside the supply line 820 to be uniform.

The controller 890 controls the first valve 863, the second valve 865, the third valve 867, and the circulation pump 868. The controller 890 may control the first valve 863 and the second valve 865 to allow a part of the processing solution to flow the first detour line 862 and the second detour line 864. Also, the controller 890 may control the third valve 867 and the circulation pump 868 to allow the processing solution to be circulated via the return line 866.

According to the exemplary embodiments, it is possible to supply chemicals at a room temperature while increasing a temperature thereof to a desired degree after a processing solution is obtained by mixing chemicals at a desired ratio in real time.

Also, according to the exemplary embodiments, it is possible to supply processing solutions having different conditions to respective chambers.

Also, according to the exemplary embodiments, it is possible to change a temperature and a flow of a processing solution in real time.

Also, according to the exemplary embodiments, it is possible to prevent temperature hunting that instantly occurs.

Also, according to the exemplary embodiments, it is possible to maintain a temperature at a nozzle part to be uniform although a processing solution is not ejected.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A substrate processing apparatus comprising:
a processing chamber containing a substrate and processing the substrate by using a processing solution; and
a supplying unit supplying the processing solution to the processing chamber,
wherein the supplying unit comprises:
a supply line through which the processing solution is supplied;
a preliminary heater installed on the supply line and preliminary heating the processing solution;
a main heater installed on the supply line at a lower stream of the preliminary heater and secondarily heating the processing solution;
a first detour line connected to the supply line to detour to the preliminary heater and comprising a first valve; and
a controller controlling the first valve.

2. The apparatus of claim 1, further comprising a second detour line connected to the supply line to detour to the preliminary heater and the main heater or the main heater and comprising a second valve controlled by the controller.

3. The apparatus of claim 1, further comprising a return line connected to the supply line to allow the processing solution to return from a lower stream of the main heater to an upper stream of the preliminary heater.

4. The apparatus of claim 3, wherein the main heater is a water bath heater to precisely control a temperature of the processing solution.

5. The apparatus of claim 1, further comprising a rate controller installed on the supply line, receiving one or more chemicals from one or more chemical suppliers and supplying a mixed processing solution to the preliminary heater.

6. The apparatus of claim 5, wherein a flow controller controlling a flow of the chemicals is installed on a line connecting the rate controller and the chemical suppliers.

7. A method of supplying a processing solution, the method comprising:
receiving and mixing chemicals from one or more chemical suppliers;
preliminary increasing a temperature of a mixed processing solution to a determined degree of temperature while the mixed processing solution passes through a preliminary heater; and
secondarily increasing the temperature of the processing solution to the determined degree of temperature by a main heater,
wherein, when over shooting occurs in the preliminary heater, a part of the processing solution at a room temperature flowing through a first detour line detouring to the preliminary heater is mixed with the processing solution whose temperature is preliminary increased.

8. The method of claim 7, wherein, when to decrease a temperature of the processing solution in real time, whose temperature is increased to the determined degree at the secondarily increasing the temperature, a part of the processing solution at the room temperature flowing through a second detour line detouring to the preliminary heater and the main heater is mixed with the processing solution whose temperature is secondarily increased.

9. The method of claim 7, wherein a water bath heater is used at the secondarily increasing the temperature in order to precisely increase the temperature of the processing solution.
